(19) United States
(12) Patent Application Publication
(10) Pub. No.: US 2020/0300362 A1
(43) Pub. Date: Sep. 24, 2020

(54) DIRT SCRAPPER ASSEMBLY

(71) Applicant: Aktiebolaget SKF, Göteborg (SE)

(72) Inventors: Balasubramanian SELVAPANDIAN, Bangalore (IN); Kunjukuttan CHERUKULAM SANKARAN, Bangalore (IN); Vishal K. PIMPLE, Aurangabad (IN); Shivling Devidas SUNDGE, Aurangabad (IN); Muragendra S. MAGADUM, Aurangabad (IN)

(21) Appl. No.: 16/754,777

(22) PCT Filed: Oct. 29, 2018
(86) PCT No.: PCT/EP2018/079532

§ 371 Date: Apr. 9, 2020

(30) Foreign Application Priority Data
Nov. 23, 2017 (IN) 201741042007

(51) Int. Cl. F16J 15/10; B62K 21/02

(52) U.S. Cl. CPC F16J 15/104; B62K 21/02

(57) ABSTRACT

A dirt scrapper assembly providing an annular stiffening structure adapted to connect with a tube for sealing the tube is disclosed. The annular stiffening structure includes a plurality of first axial sections equally spaced and extended along axial direction on an outer side of the tube. Curvature of corresponding radii is provided on the outer surface of the first axial sections. The annular stiffening structure further includes a second axial section extended along axial direction of the tube on inner side of the tube. The plurality of first axial sections and the second axial section are connected by a connection section of the stiffening structure configured to contact with an end surface of the tube. The connection section having a cut section at the bottom surface extended over the length of each of the plurality of first axial sections to provide flex to the plurality of first axial sections.

### FIELD OF INVENTION

The present disclosure relates to a field of a seal assembly. More specifically, the present disclosure relates to a seal assembly in an automotive industry.

### BACKGROUND

As known, motorcycles or bikes are equipped with a suspension mechanism to absorb shocks or vibrations as the motorcycle travels on uneven surfaces and to isolate rest of the motorcycle from the shocks. The suspension mechanism may usually include a pair of fork tubes provided at front of the motorcycle. The fork tubes comprise springs and compartments filled with fork oil to absorb the shocks. Typically, the front of the motorcycle is provided with the suspension mechanism in a telescopic fork form.

It is well known that the telescopic fork is widely used as it is simple in design and is relatively easy to manufacture and assemble. The telescopic fork comprises fork tubes coupled to an outer sleeve coupled extendedly to the fork tube. The telescopic fork uses the fork tubes comprising suspension components such as the springs and dampers internally. The fork tubes are suspended on the springs and movement of the fork tubes are controlled by damping through adjustable valving to control movement by controlling the flow of the fork oil. As such, it is important to contain the fork oil inside the fork tubes. In order to contain the fork oil, the fork tubes are sealed. The seal assembly generally comprises a plurality of annular rings fit around the fork tube.

It is necessary that the fork tubes and its assembly should be protected from environmental influences. For example, it is necessary to protect parts and components from dust, dirt particles and droplets. As such, the fork tube and the seal is provided with a dirt scrapper to protect them from dirt and/or droplets.

There have been several designs proposed in the existing art disclosing dirt scrappers. For example, a Japanese utility model to Kokai having publication No. 6-28429 discloses a dust seal comprising a primary dust seal and an axillary dust sealing lip. The auxiliary dust seal functions to scrap the dust outside. In another Japanese utility model, having an application number JP2016098869A, a dust seal provided with a lip membrane is disclosed. Further, a PCT application, numbered WO2016080189A1 discloses a dust seal body and a lip membrane.

Further, United States granted application U.S. Pat. No. 5,649,709 discloses elastomeric materials being used for the purpose of sealing the dirt scrapper. The dirt scrapper as disclosed in U.S. Pat. No. 5,649,709 comprises an annular elastomeric primary sealing member for sealing oil side of a shaft, and an annular elastomeric dust sealing member for sealing air side of the shaft was being disclosed.

Furthermore, an Indian Patent application, numbered IN201621030674 discloses an integrated dust seal and sleeve guide with pads formed by integrating dust seal and oil seal.

Referring to FIG. 1, an example of existing design of a dirt scrapper assembly 100 provided on a fork tube 115 is shown. As can be seen from FIG. 1, a dirt scrapper assembly 100 comprises a fork outer tube 110 mechanically coupled to an outer sleeve 115. Specifically, the inner diameter of the outer sleeve 115 is in cylindrical shape with outer diameter of the fork outer tube 110. The fork outer tube 110 further comprises a seal assembly 120 to protect inside of the fork outer tube 115 from dirt and/or droplets. In operation, the fork outer tube 110 is guided in axial direction with respect to the outer sleeve 115. When the fork outer tube 110 is guided in axial direction with respect to the outer sleeve 115, the fork outer tube 110 or the seal assembly 120 comes in contact with the outer sleeve 115. This results in riding discomfort. Further, the outer surface of the fork outer tube 110 wears out over time.

Therefore, there is a need to provide a seal assembly for the fork outer tube that does not come in contact with the outer sleeve during operation and protect inside of the fork outer tube during operation.

### SUMMARY OF THE INVENTION

The above-mentioned problems are addressed by providing a dirt scrapper assembly for sealing a tube which does not contact with outer sleeve and takes up forces during operation.

This summary is provided to introduce concepts related to a dirt scrapper assembly and the concepts are further described below in the detailed description. This summary is not intended to identify essential features of the claimed subject matter nor is it intended for use in determining or limiting the scope of the claimed subject matter.

In one aspect of the present disclosure, a dirt scrapper assembly for sealing a tube is disclosed. The dirt scrapper assembly comprises an annular stiffening structure adapted to connect with the tube. The annular stiffening structure comprises a plurality of first axial sections equally spaced and extended along axial direction of the tube on an outer side of the tube. The annular stiffening structure further comprises a second axial section extended along axial direction of the tube on inner side of the tube. The plurality of first axial sections and the second axial section are connected by a connection section of the stiffening structure such that bottom surface of the connection section is bought into contact with an end surface of the tube. The connection section comprises a cut section at the bottom surface extended over the length of each of the plurality of first axial sections to provide flex to the plurality of first axial sections. Each of the first axial sections comprises a snap lock hook at inner surface to connect the first axial sections with the tube via grooves provided on outer surface of the tube.

In another aspect of the present disclosure, curvature of corresponding radii is provided on the outer surface of the first axial sections such that an outer sleeve has minimum contact with the first axial sections when the outer sleeve is guided in axial direction with respect to the tube or fork pipe. In other words, the outer sleeve may come in contact with the first axial sections if there is an axial misalignment in the outer sleeve. In such a case, the first axial sections may avoid the contact with the outer sleeve thereby avoiding rubbing or wear on the tube or fork pipe.

In another aspect of the present disclosure, a dirt scrapper assembly for sealing a tube is disclosed. The dirt scrapper assembly comprises an annular stiffening structure coupled with an elastomeric structure adapted to connect with the tube. The elastomeric structure may have a contact surface connected to the tube to form a sealing arrangement between the inner surface of the tube and a second axial section and rests against the inside of the tube. The elastomeric structure enables to create an improved seal of the sealing arrangement with respect to the inside of the tube. The seal helps to prevent penetration of liquid and/or solid particles and/or liquid/gaseous medium from leaking from interior of the tube.

In another aspect of the present disclosure, a dirt scrapper assembly for sealing a tube is disclosed. The dirt scrapper assembly comprises an annular stiffening structure adapted to connect with the tube. The annular stiffening structure comprises a plurality of first axial sections equally spaced and extended along axial direction of the tube on an outer side of the tube. The annular stiffening structure further comprises a second axial section extended along axial direction of the tube on inner side of the tube. The plurality of first axial sections and the second axial section are connected by a connection section of the stiffening structure such that bottom surface of the connection section is bought into contact with an end surface of the tube. The connection section comprises a plurality of slots equally placed on the connection section. The plurality of slots is provided to allow the plurality of first axial sections to flex and to prevent from breaking during extreme pressure and during assembly of the dirt scrapper.

In yet another aspect of the present disclosure, a dirt scrapper assembly for sealing a tube is disclosed. The dirt scrapper assembly comprises an annular stiffening structure adapted to connect with the tube. The annular stiffening structure comprises a plurality of first axial sections connected mechanically to a second axial section by a connection section. The connection section comprises a relief section at an end of each of a plurality of first axial sections. The relief section is provided to improve mold construction of the plurality of first axial sections.

The foregoing portions has outlined rather broadly the features and technical advantages of the present disclosure in order that the detailed description of the disclosure that follows may be better understood. Additional features and advantages of the disclosure will be described hereinafter, which form the subject of the disclosure. It should be appreciated that the conception and specific embodiment disclosed may be readily utilized as a basis for modifying or designing other structures for carrying out the same purposes of the present disclosure. The novel features which are believed to be characteristic of the disclosure, both as to its organization and method of operation, together with further objects and advantages will be better understood from the following description when considered in connection with the accompanying figures. It is to be expressly understood, however, that each of the figures is provided for the purpose of illustration and description only and is not intended as a definition of the limits of the present disclosure.

### BRIEF DESCRIPTION OF DRAWINGS

The detailed description is described with reference to the accompanying figures. In the figures, a reference number is used to identify a part of a dirt scrapper assembly for sealing a tube. The same numbers are used throughout the drawings to refer like/similar features and components.

FIG. 1 shows a dirt scrapper assembly is shown, as known in the art;

FIG. 2A shows a cross-sectional view of a dirt scrapper assembly, in accordance with one embodiment of the present disclosure;

FIG. 2B shows a cross-sectional view of an annular stiffening structure coupled to an elastomeric structure, in accordance with one embodiment of the present disclosure;

FIG. 3A shows a cross-sectional front view of an annular stiffening structure, in accordance with one embodiment of the present disclosure;

FIG. 3B shows a top view of the annular stiffening structure of FIG. 3A;

FIG. 3C shows a perspective view of the annular stiffening structure of FIG. 3A;

FIG. 4 shows a top view of an annular stiffening structure comprising a plurality of slots provided on a connection section, in accordance with another embodiment of the present disclosure;

FIG. 5 shows a cross-sectional view of a dirt scrapper assembly, in accordance with another embodiment of the present disclosure;

FIG. 6 shows a cross-sectional view of a dirt scrapper assembly, in accordance with yet another embodiment of the present disclosure;

FIG. 7 shows a perspective view of an annular stiffening structure, in accordance with another embodiment of the present disclosure;

FIG. 8 shows a cross-sectional front view of an annular stiffening structure, in accordance with another embodiment of the present disclosure; and

FIG. 9 shows a cross-sectional view of the dirt scrapper assembly, in accordance with another embodiment of the present disclosure.

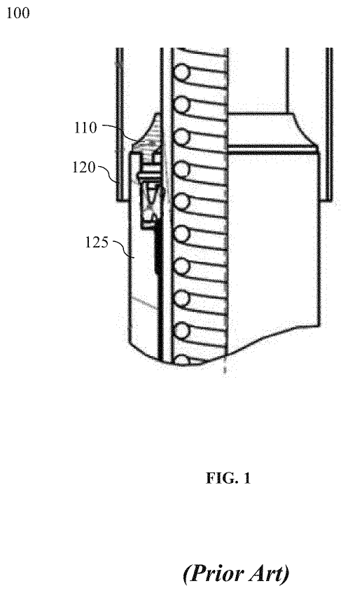

### DETAILED DESCRIPTION

The following detailed description is intended to provide example implementations to one of ordinary skill in the art, and is not intended to limit the invention to the explicit disclosure, as one or ordinary skill in the art will understand that variations can be substituted that are within the scope of the invention as described.

In the present description summarizing reference numerals will be used for objects, structures, and other components, if the component in question are described per se or more relevant components within an embodiment or within several embodiments. Passages of the specification which refer to a component, therefore also on other components in other embodiments, transferable, unless this is explicitly excluded or if it is evident from the context. When individual components referred to individual numerals are used that are based on the corresponding summary numerals. In the following description of embodiments, therefore, like reference numerals designate identical or comparable components.

Components that occur more than once in one embodiment, or in different embodiments can occur to respect some of its technical parameters executed or implemented identically and/or differently. It is for example possible that more entities can be identical, however, with respect to another parameter implemented in different ways in an embodiment with respect to a parameter.

Although the following embodiments of a dirt scrapper assembly in particular in connection with motorcycles and scooters are described, embodiments are, however, far from being limited to these applications. Thus, a dirt scrapper assembly according to an embodiment is basically for sealing of each cylindrical member with respect to a suitable tube. Depending on the specific embodiment, where appropriate, with a degree of sealing action of a moving direction of the cylindrical member to the depending pipe. As hereinafter be considered substantially movements of the cylindrical member relative to the tube is considered to take place along the axial direction of the cylindrical member and the tube.

For the motorcycles and scooters, fork seal assembly is used to prevent the dirt and droplets from entering inside of the fork tube. As such, the present disclosure discloses a dirt scrapper assembly for sealing a tube or fork pipe. The dirt scrapper assembly comprises an annular stiffening structure adapted to connect with the tube. The annular stiffening structure comprises a plurality of first axial sections equally spaced and extended along axial direction of the tube on an outer side of the tube. Further, curvature of corresponding radii is provided on the outer surface of the first axial sections such that an outer sleeve does not come in contact with the first axial sections when the outer sleeve is guided in axial direction with respect to the tube or fork pipe.

The annular stiffening structure further comprises a second axial section extended along axial direction of the tube on inner side of the tube. The plurality of first axial sections and the second axial section are connected by a connection section of the stiffening structure such that bottom surface of the connection section is bought into contact with an end surface of the tube. The connection section comprises a cut section at the bottom surface extended over the length of each of the plurality of first axial sections to provide flex to the plurality of first axial sections. Each of the first axial sections comprise a snap lock hook at inner surface to connect the first axial sections with the tube via grooves provided on outer surface of the tube.

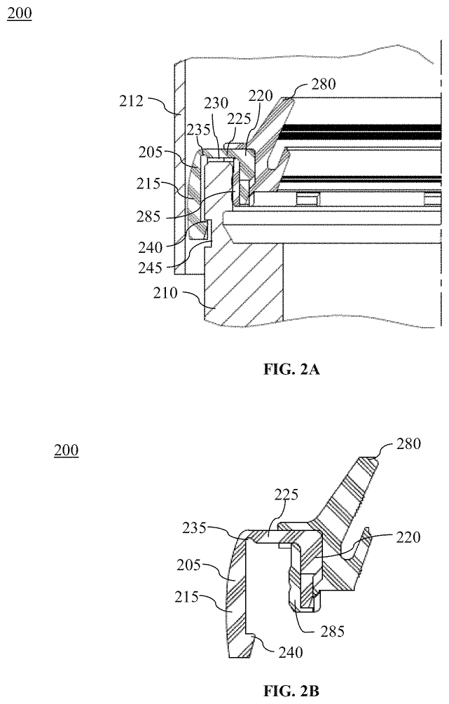

Various features and embodiments of the dirt scrapper assembly for sealing a tube are explained in conjunction with the description of FIGS. 2A-9.

FIG. 2A and 2B shows a cross-sectional view of a dirt scrapper assembly 200 for a sealing a tube 210, in accordance with one embodiment of the present disclosure. The tube 210 indicates the fork which comprises lubricating oil and damping assembly (not shown). The dirt scrapper assembly 200 comprises an annular stiffening structure 205 adapted to connect with the tube 210. Particularly, the tube 210 comprises a recess or groove 245 to connect with the annular stiffening structure 205. Other features of the annular stiffening structure 205 is explained in later part of the description. The dirt scrapper assembly 200 further comprises an outer sleeve 212 provided on outer surface of the annular stiffening structure 205. As presented above, the outer sleeve 212 and the tube 210 are guided in axial direction during operation of the front fork assembly.

The annular stiffening structure 205 comprises a plurality of first axial sections 215 extended along axial direction of the tube 210. The plurality of first axial sections 215 are on an outer side of the tube 210. The plurality of first axial sections 215 are equally spaced indicating that a section of outer circular ring of the annular stiffening structure 205 is cut at equal lengths to form a plurality of first axial sections 215. The plurality of first axial sections 215 are equally spaced to provide flexibility to the part and to prevent from breaking when the annular stiffening structure 205 goes under extreme pressure. Further, each of the plurality of first axial sections 215 may have a curvature provided on outer surface in order to minimize contact with the outer sleeve 212 during the operation. Further, the annular stiffening structure 205 comprises a second axial section 220 along axial direction of the tube 210. The second axial section 220 is provided on an inner side of the tube 210. In other words, the second axial section 220 is an inner circular ring of the annular stiffening structure 205, as shown in FIG. 2B. The plurality of first axial sections 215 are provided in a radial direction of the second axial section 220 for connection to the outside of the tube on opposite sides. In other words, the plurality of first axial sections 215 and the second axial section 220 face each other and opposed to each other in the axial direction. It is preferable to have length of each of the plurality of first axial sections 215 greater than that of the second axial section 220. However, length of the first axial sections 215 and the second axial section 220 should not be taken to be limiting the disclosure.

The annular stiffening structure 205 is tailored to a diameter of the cylindrical structure of the tube 210 such that the plurality of first axial sections 215 are formed in the area having the outer diameter of the tube 210. Further, the second axial section 220 is tailored to have the inner diameter of the tube 210. The annular stiffening structure 205 further comprises a connection section 225 which connects the plurality of first axial sections 215 and the second axial section 220. The plurality of first axial sections 215, the second axial section 220 and the connection section 225 provide a mechanically structure which is essentially U-shared structure encompassing the tube 210. It is understood that the connection section 225 may come in contact with the tube 210 directly or indirectly at an end section 230 of the tube 210. When the end section 230 of the tube 210 is brought into contact with the connection section 225 either directly or indirectly, the end section 230 of the tube 210 and the connection section 225 comes substantially perpendicular to the axial direction. In other word, the end section 230 of the tube 210 limits the tube 210 along the axial direction.

The annular stiffening structure 205 is made of one of an unfilled plastic, a Glass filled plastic, an unfilled Thermoplastic Elastomer (TPE), a Glass filled Thermoplastic Elastomer (TPE), and a polyurethane.

The connection section 225 further comprises a cut section 235 provided at bottom surface extended over the length of each of the plurality of first axial sections 215. The cut section 235 is provided such that the plurality of first axial sections 215 flexes when the annular stiffening structure 205 comes under stress during operation.

In addition, each of the plurality of first axial sections 215 comprises a snap lock hook 240 extending from inner surface. Particularly, the snap lock hook 240 is adapted to connect with the tube 210 on an outer surface of the tube 210 via the groove 245 provided on outer of the tube 210. The snap lock hook 240 helps in positive locking of the annular stiffening structure 205 to the outer surface of the tube 210 and prevents popping due to extreme pressure exerted by the outer sleeve 212. In other words, the snap lock hook 240 provides positive connection with the groove 245 provided on outer of the tube 210. The positive connection indicates a mechanical interlocking of two parts i.e., interlocking of the snap lock hook 240 and groove 245. The annular stiffening structure 205 comprising the plurality of first axial sections 215, the second axial section 220 and the connection section 225 is connected over the tube 210 such that the connection section 225 with the help of snap lock hook 240 acts as a stopper and forms a locking-connection only in one direction.

In one embodiment, the dirt scrapper assembly 200 comprises an elastomeric structure 280 extended between the annular stiffening structure 205 and the end section 230 of the tube 210. In one example, the elastomeric structure 280 is made up of rubber. The elastomeric structure 280 is connected to the annular stiffening structure 205 by means of a material connection such as by bonding or by vulcanizing. In other embodiment, the elastomeric structure 280 is connected to the annular stiffening structure 205 by welding, vulcanization techniques, post vulcanization, and other connecting mechanisms known in the art.

The annular stiffening structure 205 and the elastomeric structure 280 are bonded together to form a seal arrangement. The seal arrangement helps to avoid dirt and/or droplets from entering inside of the tube 210. In one implementation, the annular stiffening structure 205 is made up of for example, plastic may be formed integrally. The elastomeric structure 280 may additionally or alternatively not be releasably connected to the annular stiffening structure 205. The seal arrangement of the annular stiffening structure 205 and the elastomeric structure 280 may be formed using injection molding or compression molding. The elastomeric structure 280 may be bonded or vulcanized with the annular stiffening structure 205. It should be obvious to a person skilled in the art to connect the annular stiffening structure 205 with the elastomeric structure 280 using other material connection techniques.

The elastomeric structure 280 may comprise a contact surface 285 connected to the tube 210 to form a sealing arrangement between the inner surface of the tube 210 and second axial section 220 and rests against the inside of the tube 210. In other words, the contact surface 285 is provided between the inner side of the tube 210 (and inner surface of the second axial section 220 of the annular stiffening structure 205). The contact surface 285 acts as a static sealing and the second axial section 220 exerts pressure for the static sealing with the contact surface 285. The elastomeric structure 280 enables to create an improved seal of the sealing arrangement with respect to the inner side of the tube 210. The seal helps to prevent penetration of liquid and/or solid particles.

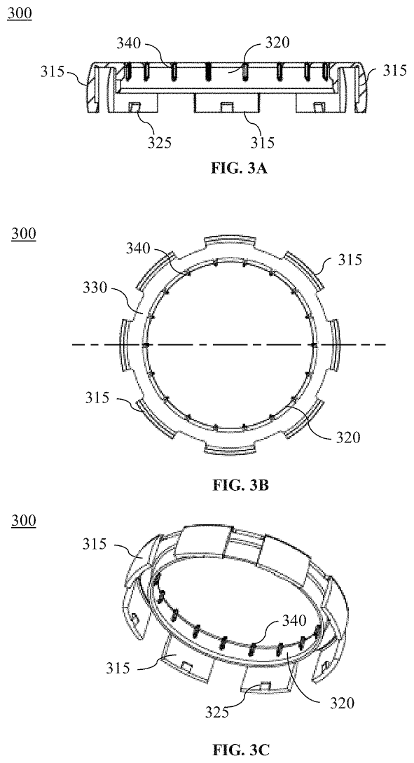

Now, referring to FIG. 3A, a cross-sectional front view of an annular stiffening structure 300 is shown, in accordance with one embodiment of the present disclosure. As can be seen, the annular stiffening structure 300 comprises a plurality of first axial sections 315. The plurality of first axial sections 315 are equally spaced indicating that a section of outer circular ring of the annular stiffening structure 300 is cut at equal lengths to form a plurality of first axial sections 315. Further, the annular stiffening structure 300 comprises a second axial section 320 along axial direction of the tube plurality of first axial sections 315. Further, each of the plurality of first axial sections 315 comprises a snap lock hook 325. The snap lock hook 325 is provided on inner surface of the first axial sections 315. Furthermore, the second axial section 320 comprises a plurality of ribs 340 equally spaced on outer surface of the second axial section 320. In other words, the plurality of ribs 340 are provided on the surface of the second axial section 320 that comes in contact with the contact section (285 in FIG. 2) of the elastomeric structure (280 in FIG. 2) i.e., away from the plurality of first axial sections 315. The plurality of ribs 340 are equally spaced to maintain circular form of the second axial section 320.

Referring to FIG. 3B, a top view of the annular stiffening structure 300 is shown, in accordance with one embodiment of the present disclosure. As can be seen, the plurality of first axial sections 315 are connected mechanically to the second axial section 320 by a connection section 330. Further, the ribs 340 provided on the second axial section 320 is shown.

Referring to FIG. 3C, a perspective view of the annular stiffening structure 300 is shown, in accordance with one embodiment of the present disclosure. As can be seen, the plurality of first axial sections 315 are connected mechanically to a second axial section 320. Each of the plurality of first axial sections 315 comprises a snap lock hook 325. Further, the second axial section 320 comprises a plurality of the ribs 340 on outer surface, as presented above.

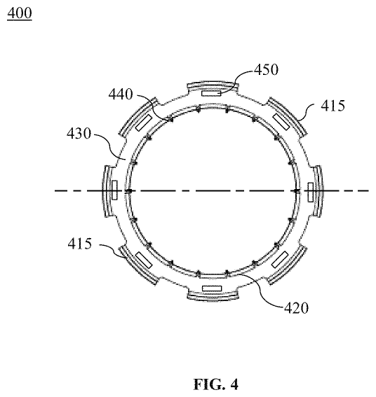

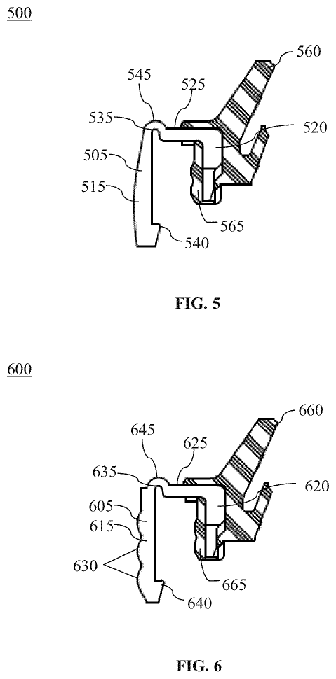

Now, referring to FIG. 4, a top view of an annular stiffening structure 400 comprising a plurality of slots 450 provided on a connection section 430 is shown, in accordance with an alternate embodiment of the present disclosure. The annular stiffening structure 400 comprises a plurality of first axial sections 415 connected mechanically to a second axial section 420 by the connection section 430. Further, the second axial section 420 comprises a plurality of the ribs 440 on outer surface. The connection section 430 comprises a plurality of slots 450 equally placed on the connection section 430. Specifically, the plurality of slots 450 are provided where the plurality of first axial sections 415 are present. The plurality of slots 450 are provided to allow the plurality of first axial sections 415 to flex and to prevent from breaking during extreme pressure.

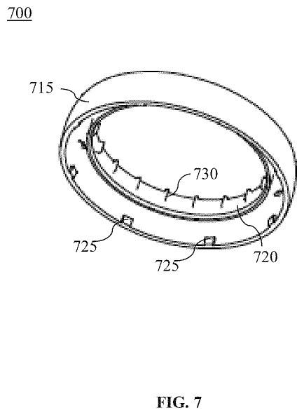

In an alternate embodiment, a protruded section may be provided for the annular stiffening structure, as shown in FIG. 5. Referring to FIG. 5, a cross-sectional view of a dirt scrapper assembly 500 comprising an annular stiffening structure 505 is shown. The annular stiffening structure 505 comprises a plurality of first axial sections 515. The annular stiffening structure 505 comprises a second axial section 520 mechanically coupled to the plurality of first axial sections 515 via a connection section 525. Each of the plurality of first axial sections 515 may further comprise a rib 540. The annular stiffening structure 505 is further connected to an elastomeric structure 560 by means of a material connection. For example, the annular stiffening structure 505 is connected to the elastomeric structure 560 by bonding or by vulcanizing. The elastomeric structure 560 comprises a contact surface 565 connected to the second axial section 520.

In the present embodiment, the connection section 525 comprises a cut section 535 provided at bottom surface extended over the length of each of the plurality of first axial sections 515. Further, the connection section 525 comprises a protruded section 545 provided on top surface extended over the length of each of the plurality of first axial sections 515. The protruded section 545 is provided as a beaded rib structure along the top surface of the connection section 525. The protruded section 545 is provided to close any split gap that may have formed between the annular stiffening structure 505 and a tube (similar to the tube 210). The cut section 535 and the protruded section 545 allows the plurality of first axial sections 515 to flex when the annular stiffening structure 505 comes under stress during operation and during assembly of the dirt scrapper 500.

In yet another alternate embodiment, a protruded section may be provided for the annular stiffening structure, as shown in FIG. 6. Further, a plurality of curvatures may be provided on the first axial sections, as shown in FIG. 6. Referring to FIG. 6, a cross-sectional view of a dirt scrapper assembly 600 comprising an annular stiffening structure 605 is shown. The annular stiffening structure 605 comprises a plurality of first axial sections 615. The annular stiffening structure 605 comprises a second axial section 620 mechanically coupled to the plurality of first axial sections 615 via a connection section 625. Each of the plurality of first axial sections 615 may further comprise a rib 640. The annular stiffening structure 605 is further connected to an elastomeric structure 660 by means of a material connection. For example, the annular stiffening structure 605 is connected to the elastomeric structure 660 by bonding or by vulcanizing. The elastomeric structure 660 comprises a contact surface 665 connected to the second axial section 620.

As can be seen, each of the plurality of first axial sections 615 is provided with a plurality of curvatures 630 on outer surface of the plurality of first axial sections 615. It should be understood that one or more curvatures 630 may be provided depending upon on the material chosen for the annular stiffening structure 605. Each of the curvatures 630 may have equal radii or varying radii depending upon the material chosen for the plurality of first axial sections 615 or the annular stiffening structure 605.

In the present embodiment, the connection section 625 may comprise a cut section 635 provided at bottom surface extended over the length of each of the plurality of first axial sections 615. Further, the connection section 625 comprises a protruded section 645 provided on top surface extended over the length of each of the plurality of first axial sections 615.

The plurality of curvatures 630 provided on outer surface of the plurality of first axial sections 615, the cut section 635 and the protruded section 645 allow the plurality of first axial sections 615 to flex when the annular stiffening structure 605 comes under stress during operation. As the plurality of first axial sections 615 flexes under stress, damage to the plurality of first axial sections 615 is minimized during operation.

In an alternate embodiment, an annular stiffening structure 700 may comprise a first axial section 715, as shown in FIG. 7. In the present embodiment, the first axial section 715 is provided as a single circular section as opposed to equally spaced multiple first axial sections (plurality of first axial sections 215 in FIG. 2A). The annular stiffening structure 700 comprises a second axial section 720 mechanically coupled to the first axial section 715 via a connection section (not shown and similar to the connection section 225). The first axial section 715 comprises a plurality of snap lock hooks 725 provided on inner surface of the first axial section 715. As can be seen, the second axial section 720 comprises a plurality of ribs 730 equally spaced on outer surface of the second axial section 720. In other words, the plurality of ribs 730 are provided on the surface of the second axial section 720 that comes in contact with the contact section (285 in FIG. 2) of the elastomeric structure (280 in FIG. 2) i.e., away from the first axial section 715. The plurality of ribs 730 are equally spaced to maintain circular form of the second axial section 720.

It should be obvious to a person skilled in the art that the cut section (cut section 635 shown in FIG. 6), and a protruded section (protruded section 645 shown in FIG. 6) may be provided in the annular stiffening structure 700, shown in FIG. 7. Further, the annular stiffening structure 700 comprising the first axial section 715 as a single circular section may have a plurality of curvatures (similar to plurality of curvatures 730).

The plurality of curvatures provided on outer surface of the first axial section 715, the cut section and the protruded section allow the first axial section 715 to flex when the annular stiffening structure 700 comes under stress during operation. As the first axial section 615 flexes under stress, damage to the first axial sections 615 is minimized during operation.

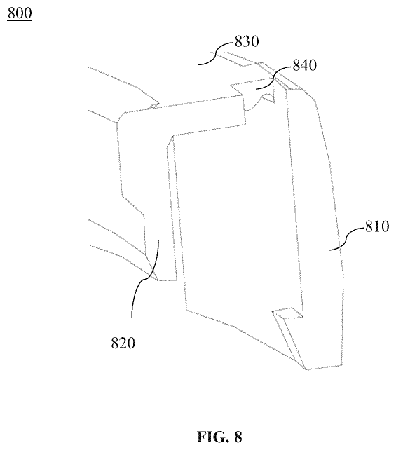

FIG. 8 is a cross-sectional front view of an annular stiffening structure 800, in accordance with an alternate embodiment of the present disclosure. The annular stiffening structure 800 comprises a plurality of first axial sections 810 connected mechanically to a second axial section 820 by a connection section 830. The connection section 830 comprises a relief section 840 at an end of each of a plurality of first axial sections 810. The relief section 840 is provided to improve mold construction of the plurality of first axial sections 810.

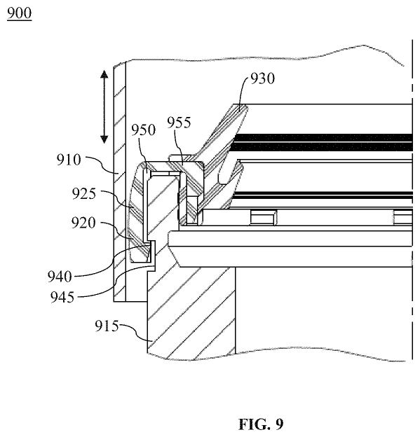

Operational features of the dirt scrapper assembly are explained with the help of FIG. 9. Referring to FIG. 9, a cross-sectional view of a dirt scrapper assembly 900 is shown. As can be seen, the dirt scrapper assembly 900 comprises an outer sleeve 910 guided in axial direction with respect to a tube or fork pipe 915. Further, the dirt scrapper assembly 900 comprises an annular stiffening structure 920 (also, the annular stiffening structure 205 in FIG. 2A and FIG. 2B). The annular stiffening structure 920 comprises a plurality of first axial sections 925 provided on an outer side of the tube 915. The annular stiffening structure 920 is mechanically coupled with an elastomeric structure 930 (sealing structure) in order to seal or lock the tube 915. Specifically, the annular stiffening structure 920 is sealed to the elastomeric structure 930 by applying pressure on the annular stiffening structure 920 (second axial section 220). As known, extreme pressure is applied on the sealing structure when the outer sleeve 910 is guided in axial direction with respect to the tube or fork pipe 915. In order to prevent the seal assembly of the annular stiffening structure 920 and the elastomeric structure 930 with the tube or fork pipe 915, snap lock hooks 940 are provided on the inner surface of the plurality of first axial sections 925. The snap lock hooks 940 gets locked with grooves 945 provided on the outer surface of the tube 915. As the snap lock hooks 940 gets locked with grooves 945, the seal assembly (annular stiffening structure 620 and elastomeric structure 630) stays intact during the movement of the outer sleeve 910 in upward motion. In other words, the snap lock hooks 940 prevents seal disassembly during the movement of the outer sleeve 910 in upward motion.

Further, the plurality of first axial sections 925 flexes when extreme pressure is exerted by the outer sleeve 910 due to a cut section 950 provided at bottom of a connection section 655. As the first axial sections 925 flex under extreme pressure, breaking of the first axial sections 925 is avoided.

Furthermore, curvature of corresponding radii is provided on the outer surface of the first axial sections 925 such that the outer sleeve 910 coming in contact with the first axial sections 925 is minimized when the outer sleeve 910 is guided in axial direction with respect to the tube or fork pipe 915. As there is minimum contact between the outer sleeve 910 and the first axial sections 925, wear on the surface of the first axial sections 925 or on the tube 915 is reduced.

In other words, the curvature on the outer surface of the first axial sections 925 is provided in a such a way that outer sleeve 910 make contact with the first axial sections 925 far away from the cut section 950 (pivot point) thereby increasing flexibility to the first axial sections 925.

In addition, mechanical stresses produced during the operation may be distributed to the plurality of the first axial sections 925. After undergoing the mechanical stresses, the first axial sections 925 may flex and sustain the mechanical stresses. Further, due to the snap lock hooks 940, the annular stiffening structure 920 is connected to the grooves 945 on outer surface of the tube 915 even when undergoing the mechanical stresses thereby not snapping the connection with the tube 915. In other words, the annular stiffening structure 925 provides the positive connection to the tube 915 on its outer side only in one direction.

It should be understood that the curvature of corresponding radii may be provided on the outer surface of the first axial sections depending on the size and shape of the outer sleeve such that the outer sleeve contact with the first axial sections is minimized when the outer sleeve is guided in axial direction with respect to the tube or fork pipe.

The length of the first axial sections and the second axial section may be chosen depending upon the diameter of the annular stiffening structure or material of the annular stiffening structure.

The dirt scrapper assembly may be used in self-locking motorcycle fork seal for smaller motorcycles and scooters. However, it can also be used as shock absorbers or other components of other motor vehicles and non-motorized vehicles.

Advantages:

The dirt scrapper assembly facilitates in sealing the tube effectively with the help of the elastomeric structure.

Further, the positive connection established between the snap lock hook and grooves allow the annular stiffening structure to withstand mechanical forces exerted during operation of the outer sleeve and the tube.

The annular stiffening structure have minimum contact with the outer sleeve due to the curvature of corresponding radii provided on outer surface of the first axial portion. Therefore, the annular stiffening structure does not wear out easily and provides comfort ride to users of the motorcycles or scooters.

The foregoing description conveys the best understanding of the objectives and advantages of the present invention. Different embodiments may be made of the inventive concept of this invention. It is to be understood that all matter disclosed herein is to be interpreted merely as illustrative, and not in a limiting sense.

### REFERENCE NUMERAL LIST

100 Dirt Scrapper Assembly (Prior Art)
110 Fork Outer Tube (Prior Art)
115 Outer Sleeve (Prior Art)
120 Seal Assembly (Prior Art)
200 Dirt Scrapper Assembly
205 Annular Stiffening Structure
210 Tube
212 Outer Sleeve
215 First Axial Sections
220 Second Axial Section
225 Connection Section
230 End Section
235 Cut Section
240 Snap Lock Hook
245 Groove
280 Elastomeric Structure
285 Contact Surface
300 Annular Stiffening Structure
315 First Axial Sections
320 Second Axial Section
325 Snap Lock Hook
330 Connection Section
340 Ribs
400 Annular Stiffening Structure
415 First Axial Sections
420 Second Axial Section
430 Connection Section
440 Ribs
450 Slots
500 Dirt Scrapper Assembly
505 Annular Stiffening Structure
515 First Axial Sections
520 Second Axial Section
525 Connection Section
535 Cut Section
540 Snap Lock Hooks
545 Protruded Section
560 Elastomeric Structure
565 Contact Surface
600 Dirt Scrapper Assembly
605 Annular Stiffening Structure
615 First Axial Sections
620 Second Axial Section
625 Connection Section
630 Curvatures
635 Cut Section
640 Rib
645 Protruded Section
660 Elastomeric Structure
665 Contact Surface
700 Annular Stiffening Structure
715 First Axial Section
720 Second Axial Section
725 Snap lock Hooks
730 Ribs
800 Annular Stiffening Structure
810 First Axial Sections
820 Second Axial Section
830 Connection Section
840 Relief Section
900 Dirt Scrapper Assembly
910 Outer Sleeve
915 Tube
920 Annular Stiffening Structure
925 First Axial Sections
930 Elastomeric Structure
940 Snap Lock Hook
945 Groove
950 Cut Section
955 Connection Section

1. A dirt scrapper assembly for sealing a tube, comprising:
an annular stiffening structure configured to connect with the tube, wherein the annular stiffening structure comprises a plurality of first axial sections equally spaced and extended along an axial direction of the tube on an outer side of the tube and a second axial section extended along the axial direction of the tube on an inner side of the tube, wherein the plurality of first axial sections and the second axial section are connected by a connection section of the stiffening structure such that a bottom surface of the connection section is brought into contact with an end surface of the tube, wherein the connection section comprises a cut section at the bottom surface extended over the length of each of the plurality of first axial sections to provide flex to the plurality of first axial sections, and wherein each of the first axial sections comprises a snap lock hook at an inner surface to connect the first axial sections with the tube via grooves provided on outer surface of the tube.

2. The dirt scrapper assembly as claimed in claim 1, further comprises a plurality of ribs equally spaced on outer surface of the second axial section.

3. The dirt scrapper assembly as claimed in claim 1, further comprises a plurality of slots equally spaced on a connection section of an annular stiffening structure.

4. The dirt scrapper assembly as claimed in claim 1, wherein a connection section of a stiffening structure comprises a relief section at an end of each of a plurality of first axial sections.

5. The dirt scrapper assembly as claimed in claim 1, wherein the outer surface of each of the plurality of first axial sections is curved to minimize contact with an outer sleeve.

6. The dirt scrapper assembly as claimed in claim 1, wherein the length of the each of the plurality of first axial sections is greater than the length of the second axial section.

7. The dirt scrapper assembly as claimed in claim 1, wherein the annular stiffening structure is made of one of an unfilled plastic, a Glass filled plastic, an unfilled Thermoplastic Elastomer (TPE), a Glass filled Thermoplastic Elastomer (TPE), and a polyurethane.

8. The dirt scrapper assembly as claimed in claim 1, further comprises an elastomeric structure mechanically connected with the annular stiffening structure using at least one of vulcanization technique, post vulcanization and bonding.

9. The dirt scrapper assembly as claimed in claim 8, wherein the elastomeric structure comprises a contact surface connected with the tube, wherein the contact surface is provided between the inner side of the tube and the inner surface of the second axial section of the annular stiffening structure.

10. The dirt scrapper assembly as claimed in claim 1, wherein the connection section comprises a protruded section at the top surface extended over the length of each of the plurality of first axial sections to provide flex to the plurality of first axial sections.
